(19) United States
(12) Patent Application Publication
(10) Pub. No.: US 2007/0237132 A1
(43) Pub. Date: Oct. 11, 2007

(54) Apparatuses, methods and systems to design, generate and order customized sheet metal materials

(76) Inventor: Robert Baschnagel III, Bayside, NY (US)

Correspondence Address: Robert Baschnagel III, 36-17 212 Street, Bayside, NY, 11361, US

(21) Appl. No.: 11/402,338

(22) Filed: Apr. 11, 2006

(51) Int. Cl. H04L 12/66

(52) U.S. Cl. 370/352

(57) ABSTRACT

The disclosure details the implementation of an apparatuses, methods, and systems to design, generate, and order customized sheet metal materials based on price sensitive attributes as well as a pricing method therefor. The Customized Sheet Metal Materials Order System (CSMMOS) enables the specification various metal products with regard to price, materials, multi-point measurements, weight and shape within certain pre-determined tolerances for manufacture, all performed via a Web form interface. The CSMMOS includes a Web server obtains user inputs to specify various price-sensitive sheet metal attributes and generates a highly specific and precise purchase order/s. The CSMMOS also allows other resellets to integrate it into their e-commerce systems so that they may provide users with an interface for specifying certain customizations under their own retail brand presence.

This patent application makes reference to and seeks the priority date of the Provisional Patent Application Attorney Docket No. 4780-4000 to Baschnagel filed the 26 day of Apr. in the year 2005.

### FIELD

The present invention is directed generally to an apparatuses, methods, and systems of electronic commerce, and more particularly, to apparatuses, methods and systems to design, generate, and order customized sheet metal materials.

### BACKGROUND

Internet

As internet usage increases, the amount of information available on the Internet also increases. The information that exists on the Internet is of many different types, including documents in many formats such as : computer software, databases, discussion lists, electronic journals, library catalogues, online information services, mailing lists, news groups, streaming media, and the like. Fortunately, much of the information on the Internet can be accessed through the World-Wide Web using a web browser to interact with the network in a user-friendly way.

Networks

Networks are commonly thought to consist of the interconnection and interoperation of clients, servers, and intermediary nodes in a graph topology. It should be noted that the term “server” as used herein refers generally to a computer, other device, software, or combination thereof that processes and responds to the requests of remote users across a communications network. Servers serve their information to requesting “clients.” A computer, other device, software, or combination thereof that facilitates, processes information and requests, and/or furthers the passage of information from a source user to a destination user is commonly referred to as a “node.” Networks are generally thought to facilitate the transfer of information from source points of destinations.

Transmission Control Protocol-Internet Protocol (TCP/IP)

The proliferation and expansion of computer systems, databases, and networks of computers has been facilitated by an interconnection of such systems and networks in an extraterritorial communications network commonly referred to as the Internet. The Internet has developed and largely employs the Transmission Control Protocol-Internet Protocol (“TCP/IP”.) TCP/IP was developed by a Department of Defense (DoD) research project to interconnect networks, i.e. the Internet. The development of TCP/IP was in part driven by a requirement by the DoD to have a network that will continue to operate even if damaged during battle, thus allowing for information to be routed around damaged portions of the communications network to destination addresses. Of course, if the source or destination address location itself is rendered inoperable, such delivery will not be possible.

The Internet is a packet-switched network and thus, information on the Internet is broken up into pieces, called packets, and transmitted in packet form. The packets contain IP addressing information called headers, which are used by routers to facilitate the delivery of the packets from a source to a destination across intermediary nodes on the Internet. Upon arrival at the destination, the packets are reassembled to form the original message, and any missing packets are requested again.

The IP component of the protocol is responsible for routing packets of information based on a four byte addressing mechanism; the address is written as four numbers separated by dots, each number ranging from 0 to 255, e.g. “123.255.0.123.” IP addresses are assigned by Internet authorities and registration agencies, and are unique.

The TCP portion of the protocol is used for verifying that packets of information are correctly received by the destination computer from the source, and if not, to retransmit corrupt packets. Other transmission control protocols are also commonly used that do not guarantee delivery, such as User Diagram Protocol (UDP.)

World Wide Web

The proliferation and expansion of the Internet, and particularly the World Wide Web (“the web”,) have resulted in a vast and diverse collection of information. Various user interfaces that facilitate the interaction of users with information technology systems (i.e., people using computers) are currently in use. An information navigation interface called WorldWideWeb.app (“the web) was developed in 1990. Subsequently, information navigation interfaces such as web browsers have become widely available on almost every computer operating system platform.

Generally, the web is the manifestation and result of a synergetic interoperation between user interfaces (e.g., web browsers,) servers, distributed information, protocols, and specifications. Web browsers were designed to facilitate navigation and access to information, while information servers were designed to facilitate provision of information. Typically, web browsers and information servers are disposed in communication with one another through a communications network. Information Servers function to serve information to users that typically access the information by way of web browsers. As such, information servers typically provide information to users employing web browsers for navigating and accessing information on the web. Microsoft's Internet Explorer and Netscape Navigator are examples of web browsers. In addition, navigation user interface devices such as WebTV have also been implemented to facilitate web navigation. Microsoft Information Server and Apache are examples of information servers.

### SUMMARY

The Customized Sheet Metal Materials Order System (CSMMOS) enables the specification various metal products via a Web form interface. The CSMMOS includes a Web server obtains user inputs to specify various metal materials and generates highly specific and precise purchase orders. The CSMMOS also allows other resellers to integrate it into their e-commerce systems so that they may provide users an interface for specifying metal materials under their own retail brand presence.

### DESCRIPTION OF THE PRIOR ART

The use of customized applications is known in the prior art. More specifically, systems heretofore devised and utilized are known to consist generally of familiar, expected and obvious structural configurations, notwithstanding the myriad of functional differences and different applications encompassed by the prior art which have been developed for the fulfillment of countless objectives and requirements. In addition to meeting the particular objectives and requirements, customized and customer-specific applications can be difficult to adapt to different industries which mandate different functional requirements and settings, thus making existing system applications less than desirable to use. The prior art, although each invention or existing system or application may benefit it's respective user or industry, remains almost entirely inapplicable to other industries. Namely, any attempt to apply the prior art to an inapplicable industry is like trying to erect a jigsaw puzzle using inapposite pieces.

This patent application makes reference to and seeks the priority date of the Provisional Patent Application Attorney Docket No. 4780-4000 to Baschnagel filed the 26 day of Apr. in the year 2005.

U.S. Pat. No. 5,570,291 to Dudle (1996) shows a system which streamlines the process of receiving and transmitting data between the sales site and the corporate office locations in order to generate contracts and to provide price estimates based on the tables and the item specifications, as well as within certain estimate parameters, which were entered by the sales representative or customer at the sales site and then transmitted to the corporate office. However, the system fails to address the capacity to customize a plurality of specific attributes. Additionally, it fails to provide for necessary customized client-specific pricing and discount exceptions, especially with regard to setting any low prices on specific attributes or portion of the project.

U.S. Pat. No. 5,666,493 to Wojcik (1997) shows a system for managing and fulfilling customer orders in a food processing and distribution environment. More specifically, the system keeps tracks of and generates financial records, and further maintains a logistic function for processing orders and streamlining the same into appropriate bundles for transportation efficiency. The system, albeit a purported benefit to its industry, fails to address a multi-tiered customized system for other industries applications.

U.S. Pat. No. 5,870,719 to Maritzen (1999) shows a platform-independent, usage-independent, location-independent quotation configuration system to generate quotations in real-time. The system utilizes JAVA applications and business rules in order to compute the final quote dictated by the system and the user's choice of quantity; additionally allowing the user to save, fax or otherwise send the quote to a distant medium of correspondence. Despite the systems advantages, the system fails to create user-specific discounts upon the system server's identification of any special status of the client. Furthermore the system fails to address any attribute-based product with a plurality of customization options. Consequently, the system is represented as, and acts as, a more efficient method of generalizing a quote for general consumer transactions; not for more difficult and intricate transactions which require a greater level of price-sensitive attributes, as well as a greater level of involvement and micro-management by the administrator.

U.S. Pat. No. 5,930,768 to Hooban shows a system allowing for an internet user to customize the manufactured orders for recording media. The system is prompted for the object recording media, upon which the system is thereby engaged to write the sequenced custom selected data files onto the recording media, such as a CD-R. Although the invention allows for customized selection of the song, the system merely rewrites the selections from a pre-determined and static database, upon which the only customization is the selection of songs from a database; there is no customized fabrication process initiated by the system other than copying onto a CD-R or like medium.

U.S. Pat. No. 5,960,411 to Hartman (1999) shows a method and system for ordering items over the internet. More specifically, the invention pertains to a method of making the process of transmitting identity sensitive information (such as credit card information) over the internet less prone to capture by undesired third parties.

U.S. Patent Application No. 20030065586 to Shaftel shows a product pricing system for achieving product pricing and selection for gemstones based on attributes unique to the gemstone industry, to wit: shape, color, clarity grading, weight, symmetry grading, fluorescence grading, and a lab certification identifier. The system divides the product attributes into 2 sets of pluralities to achieve a competitive price based on said attributes in conjunction with a modification factor set within a pre-defined range to determine said competitive price of the gem. However, the invention is limited to the gem industry and is a comparative pricing engine and in no way performs as a system for generating customized fabrications catered to the clients unique specifications.

U.S. Patent Application No 20030172350 to Reed shows a internet wire-mesh merchandising system to coordinate transactions dealing with available combinations of wire-mesh material, size, and mesh count. The capacity of the website and the navigation of the product line is qualified by the available combinations which are pre-determined by the administrator, which links the user to different varieties by hyperlinking the user based on their selection. The system is not able to address customized fabrications not within the ambit of the pre-determined combinations set forth by the administrator of the website.

In these respects, the customized sheet metal application according to the present invention departs from the conventional concepts and designs of the prior art, and in doing so provides a method and apparatus primarily developed for the purpose of permitting a user to customize their application and product selection to their specific needs while simultaneously providing the administrator with the ability to create customer-specific pricing on entire products and specific attributes; thus creating a greater ability to micro-manage sales as well as streamlining the different processes which have heretofore required human interaction to customize or otherwise price the user-specific customizations or pricing thereof.

### BRIEF DESCRIPTION OF THE DRAWINGS

In accordance with the present disclosure, the accompanying drawings illustrate various non-limiting, example, inventive aspects of a Customized Sheet Metal Materials Order System (CSMMOS):

FIGURE 1 is of a clock diagram illustrating embodiments of a Customized Sheet Metal Materials Order System controller;

APPENDIX 1 details Customized Sheet Metal Materials Order System with screen shots and descriptions;

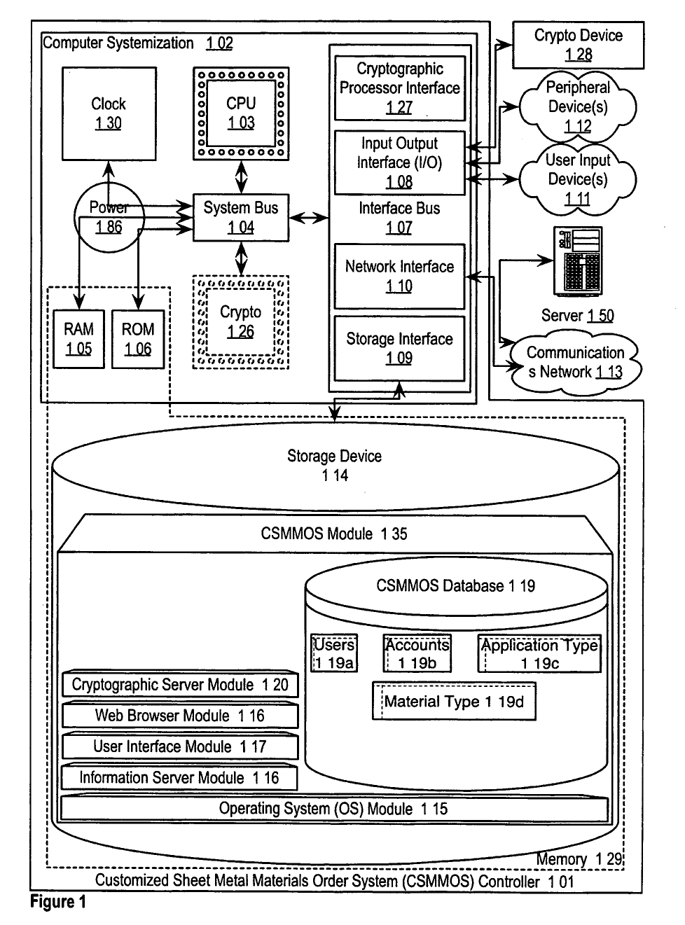

The leading number of each reference number within the drawings indicates the first figure in which that reference number is introduced. As such, reference number 101 is introduced in FIGURE 1.

### DETAILED DESCRIPTION

Customized Sheet Metal Materials Order System Controller

FIGURE 1 is a block diagram illustrating embodiments of a Customized Sheet Metal Materials Order System (“CSMMOS”) controller 101. In this embodiment, the CSMMOS controller 101 may serve to process, search, serve, identify, instruct, generate, match, and/or update material specifications, purchase orders, and/or other related data.

Typically, users, which may be people and/or other systems, engage information technology systems (e.g., commonly computers) to facilitate information processing. In turn, computers employ processors to process information; such processors are often referred to as central processing units (“CPU”.) A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer, memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the CSMMOS controller 101 may be connected to and/or communicate with entities such as, but not limited to: one or more users from user input devices 111; peripheral devices 112; a cryptographic processor device 128; and/or a communications network.

Networks are commonly thought to comprise the interconnection and interoperation of clients, servers, and intermediary nodes in a graph topology. It should be noted that the term “server” as used throughout thus disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly referred to a “router.” There are many forms of networks such as Local Area Networks (LANs), Pico networks, Wide Area Networks (WANs), etc.,. For example, the Internet is generally accepted as being an interconnection of a multitude of networks whereby remote clients and servers may access and interoperate with one another.

A CSMMOS controller 101 may be based on common computer systems that may comprise, but are not limited to, components such as: a computer systemization 102 connected to memory 129.

Computer Systemization

A computer systemization 102 may comprise a clock 130, central processing unit (“CPU”) 103, a read only memory (“ROM”) 106, a random access memory (“RAM”) 105, and/or an interface bus 107, and most frequently, although not necessarily, are all interconnected and/or communicating through a system bus 104. Optionally, the computer systemization may be connected to an internal power source 186. Optionally, a cryptographic processor 126 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, and/or Xscale; and/or the like processor(s). The CPU interacts with memory through signal passing through conductive conduits to execute stored program code according to conventional data processing techniques. Such signal passing facilities communication with the CSMMOS controller and beyond through various interfaces. Should processing requirements dictate a greater amount speed, parallel, mainframe, and/or super-computer architectures may similarly be employed. Alternatively, should deployment requirements dictate greater portability, smaller Personal Digital Assistants (PDAs) may be employed.

Power Source

The power source 186 may be of any standard form for powering small electronic circuit board devices such as the following power cells: alkaline, lithium hydride, lithium ion, nickel cadmium, solar cells, and/or the like. Other types of AC or DC sources may be used as well. In the case of solar cells, in one embodiment, the case provides an aperture through which the solar cell may capture photonic energy. The power cell 186 is connected to at least one of the interconnected subsequent components of the CSMMOS thereby providing an electric current to all subsequent components. In one example, the power source 186 is connected to the system bus component 104. In an alternative embodiment, an outside power source 186 is provided through a connection across the I/O 108 interface. For example, a USB and/or IEEE 1394 connection carries both data and power across the connection and is therefore a suitable source of power.

Interface Adapters

Interface bus(es) 107 may accept, connect, and/or communicate to a number of interface adapters, conventionally although not necessarily in the form of adapter cards, such as but not limited to: input/output interfaces (I/O) 108, storage interfaces 109, network interfaces 110, and/or the like. Optionally, cryptographic processor interfaces 127 similarly may be connected to the interface bus. The interface bus provides for the communications of interface adapters with one another as well as with other components of the computer systemization. Interface adapters conventionally connect to the interface bus via a slot architecture. Accelerated Graphics Port (AGP), Card Bus, (Extended) Industry Architecture ((E)ISA), Micro Channel Architecture, NuBus, Peripheral Component Interconnect (Extended) (PCI(x)), PCI Express, Personal Computer Memory Card International Association (PCMCIA), and/or the like.

Storage interfaces 109 may accept, communicate, and/or connect to a number of storage devices such as, but not limited to: storage devices 114, removable disc devices, and/or the like. Storage interfaces may employ connection protocols such as, but not limited to: (Ultra) (Serial) Advanced Technology Attachment (Packet Interface) ((Ultra)(Serial) ATA(PI), (Enhanced Integrated Drive Electronics ((E)IDE), Institute of Electrical and Electronics Engineers (IEEE), Universal Serial Bus (USB), and/or the like.

Network interfaces 110 may accept, communicate, and/or connect to a communications network 113. Network interfaces may employ connection protocols such as, but not limited to: direct connect, Ethernet (thick, thin, twisted pair 10/100/1000 Base T, and/or the like), Token Ring, wireless connection such as IEEE 802.11 a-x, and/or the like. A communications network may be any one and/or the combination of the following: a direct interconnection: the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized firm of an input output interface. Further, multiple network interfaces 110 may be used to engage with various communications network types 113. For example, multiple network interfaces may be employed to allow for the communication over broadcast, multicast, and/or unicast networks.

Input Output Interfaces (I/O) 108 may accept, and/or connect to user input devices 111, peripheral devices 112, cryptographic processor devices 128, and/or the like. I/O may employ connection protocols such as, but not limited to: Apple Desktop Bus (ADB); Apple Desktop Connector (ADC); audio; analog; digital; monaural; RCA, stereo, and/or the like; IEEE 1394a/b; infrared; joystick; keyboard; midi; optical; PC AT; PS/2; parallel; radio; serial; USB; video interface; BNC, coaxial, composite, digital, Digital Visual Interface (DVI), RCA, RF antennae, S-Video, VGA, and/or the like; wireless and/or the like. A common output device is a television set 145, which accepts signal from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.,.)

User input devices 111 may be card readers, dongles, finger print readers, gloves, graphic tablets, joysticks, keyboards, mouse (mice), remote controls, retina readers, trackballs, trackpads, and/or the like.

Peripheral devices 112 may be connected and/or communicate to I/O and/or other facilities of the like such as network interfaces, storage interfaces, and/or the like. Peripheral devices may be audio devices, cameras, dongles (e.g., copy for protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the CSMMOS controller may be embodied as an embedded, dedicated and/or monitor-less (i.e., headless) device, wherein access would be provided over a network interface connection.

Cryptographic units such as, but not limited to, microcontrollers, processors 126, interfaces 127, and/or devices 128 may be attached, and/or communicate with the CSMMOS controller. A MC68HC16 microcontroller, commonly manufactured by Motorola Inc., may be used for and/or within cryptographic units. Equivalent microcontrollers and/or processors may also be used. The MC86HC16 microcontroller utilizes a 16-bit multiply-and-accumulate instruction in the 16 MHz configuration and requires less that one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor ti affect the storage and/or retrieval of information is regarded as memory 129. However, memory is a fungible technology and resource, thus, any number of memory embodiments may be employed in lieu of or in concert with one another. It is to be understood that a CSMMOS controller and/or a computer systemization may employ various forms of memory 129. For example, a computer systemization may be configured wherein the functionality of on-chip CPU memory (e.g., registers, RAM, ROM, and an y other storage devices are provided by a paper punch tape card mechanism; of course such an embodiment would result in an extremely slow rate of operation. In a typical configuration, memory 129 will include ROM 106, RAM 105, and a storage device 114. A storage device 11 may be any conventional computer system storage. Storage devices may include a drum; a (fixed and/or removable) magnetic disk drive; a magneto-optical drive; am optical drive (i.e., CD-ROM/RAM/Recordable ( R) , ReWritable (RW), DVD R/RW etc.,); and/or other devices of the like. Thus, a computer systemization generally requires and makes use of memory.

Module Collection

The memory 129 may contain a collection of program and/or database modules and/or data such as, but not limited to: operating system module(s) 115 (operating system); information server module(s) 116 (information server); user interface module(s) 117 (user interface); Web browser module(s) 118 (Web browser); database(s) 119; cryptographic server module(s) 120 (cryptographic server); CSMMOS module(s) 135; and/or the like (i.e., collectively a module collection). These modules may be stored and accessed from the storage devices and/or from storage devices accessible through an interface bus. Although non-conventional software modules such as those in the module collection, typically, are stored in a local storage device 114, they may also be loaded and/or stored in memory such as: peripheral devices, RAM, remote storage facilities, through a communications network, ROM, various forms of memory, and/or the like.

Operating System

The operating system module 115 is executable program code facilitating the operation of a CSMMOS controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the CSMMOS controller to communicate with other entities, through a communications network 113. Various communication protocols may be used by the CSMMOS controller as a subcarrier transport mechanism for interaction, such as, but not limited to: multicast, TCP/IP, UDP, unicast, and/or the like.

Information Server

An information server module 116 is stored program code that is executed by the CPU. The information server may be a conventional Internet information server such as, but not limited to: Apache Software Foundation's Apache, Microsoft Internet Information Server, and/or the like. The information server may allow for the execution of program modules through facilities such as Active Server Page (ASP), ActiveX, (ANSI) (Objective) C (++), C#, Common Gateway Interface (CGI) scripts, Java, JavaScript, Practical Extraction Report Language (PERL), Python, WebObjects, and/or the like. The information server may support secure communications protocols such as, but not limited to: File Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on a CSMMOS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the CSMMOS database 119, operating systems, other program modules, user interfaces, Web browsers, and/or the like.

Across to the CSMMOS database may be achieved through a number of database bridge mechanisms such as through scripting languages as enumerated below (e.g.,CGI) and through inter-application communication channels as enumerated below (e.g., CORBA, Web objects, etc.,.) Any data requests through a Web browser are parsed through the bridge mechanism into appropriate grammars as required by the CSMMOS. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the CSMMOS as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called used interfaces. Graphical user Interfaces (GUI) such as the Apple Macintosh Operating System's Aqua, Microsoft Window's XP, or Unix's X-Windows provide a baseline of accessing and displaying information graphically to users.

A user interface module 117 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like,) myth TV, and/or the like. The user interface may allow for the display, execution, interaction, manipulation, and/or operation of program modules and/or system facilities through textual and/or graphical facilities. The user interface provides a facility through which user may afect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 118 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScipt, ActiveC, and/or the like. Web browsers and like information access tools may be integrated into PDAs, cellular telphones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests and/or responses. Of course, in place of a Web browser and information server, a combined application may be developed to perform similar functions of both. The combined application would similarly affect the obtaining and the provision of information to users, user agents, and/or the like from CSMMOS enabled nodes. The combined application may be nugatory on systems employing standard Web browsers.

Cryptographic Server

A cryptographic server module 120 is stored program code that is executed by the CPU 103, cryptographic processor 126, cryptographic processor interface 127, cryptographic processor device 128, and/or the like. Cryptographic processor interfaces will allow for expedition of encryption and/or decryption requests by the cryptographic module; however the cryptographic module, alternatively may run on a conventional CPU. The cryptographic module allows for the encryption and/or decryption of provided data. The cryptographic module allows for both symmetric and asymmetric (e.g., Pretty Good Protection (PGP)) encryption and/or decryption. The cryptographic module may employ cryptographic techniques such as, but not limited to: digital certificates (e.g., X.509 authentication framework,) digital signatures, enveloping, password access protection, public key management, and/or the like. The cryptographic module will facilitate numerous (encryption and/or decryption) security protocols such as, but not limited to: checksium, Data Encryption Standard (DES), Elliptical Curve Encryption (ECC), International Data Ecryption Algorithm (IDEA), Message Digest 5 (MD5, which is a one way hash function), passwords, Rivest Cipher (RC5), Rijndael, RSA (which is an Internet encryption and authentication system that uses an algorithm as developed in 1977 by Ron Rivest, Adi Shamir, and Leonard Adelman), Secure Hash Algorithm (SHA), Secure Socket Layer (SSL), Secure Hypertext Transfer Protocols (HTTPS), and/or the like. Employing such encryption security protocols, the CSMMOS may encrypt all incoming and/or outgoing communications and may serve as node within a virtual private network (VPN) with a wider communications network. The cryptographic module facilitates the process of “security authorization” whereby access to a resource is inhibited by a security protocol wherein the cryptographic module effects authorized access to the secured resource. In addition, the cryptographic module may provide unique identifiers of content, e.g., employing and MD5 hash to obtain a unique signature for a digital audio file. A cryptographic module may communicate to and/or with other modules in a module collection, including itself, and/or facilities of the like. The cryptographic module supports encryption schemes allowing for the secure transmission of information across a communications network to enable a CSMMOS module to engage in secure transactions if so desired. The cryptographic module facilitates the secure accessing of resources on CSMMOS and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

CSMMOS Database

A CSMMOS database module 119 may be embodied in a database and its stored data. The database is stored program code, which is executed by the CPU; the stored program code portion configuring the CPU to process the stored data. The database may be a conventional, fault tolerant, relational, scalable, secure database such as Oracle or Syabase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the CSMMOS database may be implemented using various standard data-structures, such as an arrayt, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may related to other object collections by some common attributes. Object-oriented databases perform similarly to relational databases with the exception that objects are not just pieces of data but may have other types of functionality encapsulated within a given object. If the CSMMOS database is implemented as a data-structure, the use of the CSMMOS database 119 may be integrated into another module such as the CSMMOS module 135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database module 119 includes several tables 119a-d. A users table 119a includes fields such as, but not limited to: a user name, address, user_id, account_id, order_id, and/or the like. The user table may support and/or track multiple entity accounts on a CSMMOS. An accounts table 119b includes fields such as, but not limited to: account_id, admin_user_id (a user given administrative status to control the account), account_level, user_id, and/or the like. For example, a reseller may have their uniqye account_id key field used as part of the user account table as one way to track orders per reseller. An application_type table 119c includes fields such as, but not limited to: application_id, material_id, account_id, and/or the like. For example, various application types may include flashing, gravel stops, gutters, copings, cleets, corners, angles, and/or the like. A material_type table 119d includes fields such as, but not limited to: material_id, application_id, account_id, and/or the like.

In one embodiment, the CSMMOS database may interact with other database systems. For example, employing a distributed database system, queries and data access by CSMMOS modules may treat the combination of the CSMMOS database, an integrated data security layer database as a single database entity.

In one embodiment, user program may contain various user interface primitives, which may serve to update the CSMMOS. Also, various accounts may require custom database tables depending upon the environments and the types of clients a CSMMOS may need to serve. It should be noted that any unique fields may be designated as a key field throughout. In an alternative embodiment, these tables have been decentralized into their own databases and their respective database controllers (i.e. individual database controllers for each of the above tables.) Employing standard data processing techniques, one may further distribute the databases over several computer systemizations and/or storage devices. Similarly, configurations of the decentralized database controllers may be varied by consolidating and/or distributing the various database modules 119a-j. The CSMMOS may be configured to keep track of various settings, inputs, and parameters via database controllers.

A CSMMOS database may communicate to and/or with other modules in a module collection, including itself, and/or facilities of the like. Most frequently, the CSMMOS database communicates with a CSMMOS module, other program modules, and/or the like. The database may contain, retain, and provide information regarding other nodes and data.

CSMMOS

A CSMMOS module 135 is stored program code that is executed by the CPU. The CSMMOS affects accessing, obtaining and the provision of information, services, transactions, and/or the like across various communications networks.

The CSMMOS module enables the specification various metal products via a Web form interface. The CSMMOS employs the Web server and user interface modules to obtain user inputs to specify various metal materials and generates highly specific and precise purchase orders.

A CSMMOS module enabling access of information between nodes may be developed by employing standard development tools, such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. In one embodiment, the CSMMOS server employs a cryptographic server to encrypt and decrypt communications. A CSMMOS module may communicate to and/or with other modules in a module collection, including itself, and/or facilities of the like. Most frequently, the CSMMOS module communicates with a CSMMOS database, operating systems, other program modules, and/or the like. The CSMMOS may contain, communicate, generate, obtain, and/or provide module, system, user, and/or data communications, requests, and/or responses.

Distributed CSMMOS

The structure and/or operation of any of the CSMMOS node controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data processing techniques. Furthermore, single instances may also be distributed across multiple controllers and/or storage devices; e.g., databases. All program module instances and controllers working in concert may do so through standard data processing communication techniques.

The configuration of the CSMMOS controller will depend on the context of system development. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g. pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE, and or the like), Common Object Request Broker Architecture (CORBA), process pipes, shared files, and/or the like. Messages sent between discrete module components for intra-application communication or within memory spaces of a singular module for intra-appk

A CSMMOS module enabling access of information between nodes may be developed by employing standard development tools such as, but not limited to: (ANSI) (Objective-) C (++), Apache modules, binary executables, database adapters, Java, JavaScript, mappingtools, procedural and object oriented development tools, PERL, Python, shell scripts, SQL commands, web application server extensions, WebObjects, and/or the like. In one embodiment, the CSMMOS server employs a cryptographic server to encrypt and decrypt communications. A CSMMOS module may communicate to and/or with other modules in a module collection, including itself, and/or facilities of the like. Most frequently, the CSMMOS module communicates with a CSMMOS database, operating systems, other program modules, and/or the like. The CSMMOS may contain, communicate, generate, obtain, and/or provide program module, system, user, and/or data communication requests, and/or responses.

Distributed CSMMOS

The structure and/or operation of any of the CSMMOS node controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g. databases. All program module instances and controllers working in concert may do so through standard data processing communication techniques.

The configuration of CSMMOS controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g. pointers), internal messaging, object instance variable communication, shared memory space, variable passing, and/or the like.

If module collection componetns are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages withing and between modules. Again, the configuration will depend upon the context of system deployment.
APPENDIX 1 details BookMark Performance Indices;
APPENDIX 2 details New Performance Indices for Insurance Investors;
APPENDIX 3 details Eliminating the Noise in Attribution Analysis.

The entirety of the disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. In describing embodiments of the invention, in some cases specific terminology has been used for the sake of clarity, however, the invention is not intended to be limited to and/or by the specific terms so selected, and it is to be understood that each specific term includes all technical equivalents which operate in a similar manner to accomplish a similar purpose. It should be noted that terms and or phraseology in this disclosure are not exhaustive in detail, and are not provided as definitive definitions. Rather, the terms are provided herein simply as an aid to the reader. The terms are not limiting of the disclosure and/or claims herein. The use of the terms may contemplate any of the broader, and/or multiple meanings found in common use, dictionaries, technical dictionaries, and/or in actual use in the technical arts, as well as any broadening made throughout this disclosure. Also, the advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, sequence, structural, temporal, and/or topological modifications may be made without departing from the scope and/or spirit of the disclosure. As such, all examples and/or embodiments are deemed to be non-limiting throughout this disclosure. Also, no inference should be drawn regarding those embodiments discussed herein, relative to those not discussed herein other than it is as such for purposes of space and reducing repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that aspects of the disclosure, such as advantages, embodiments, examples, features, functional, logical, organizational, sequence, structural, temporal, topological and/or other aspects are not to be considered limitations on the disclosure are defined by the claims or limitations on equivalents to the claims.

What is claimed is:

1. A processor-implemented internet merchandising system to generate live price quotes calculated by pre-determined algorithmic formulas for customized sheet-metal products in a plurality of steps, the customization and computations of price-sensitive attributes, including in combination: materials, multi-point measurements, shapes, and weight, within certain pre-defined tolerances for manufacture;
a pricing method automatically and immediately available upon selection of a plurality of price-sensitive attributes allowing for live pricing methods, including in combination: special pricing Attorney Docket No.: RPA 4780-4000 based on prior authorization by the administrator whereby the pre-defined lowest price the administrator is willing to sell for, is pre-determined for a specific client, and discount pricing based on prior authorization whereby the principal amount is discounted in it's entirety before taxes by a percentage entered in by the administrator for that specific client.

2. The live price quotes of claim 1 wherein the customizations and computation of price-sensitive attributes, includes: materials, multi-point measurements, shapes, and weight, said attributes appear in a plurality of individual steps for each attribute whereby the system can add the computation of all applicable customizations to achieve a price quote subject to adjustment by any special pricing, if applicable for the instant client.

3. The customized products of claim 1 wherein the entry of such pre-determined products and the applicable measurements thereto, are entered by the administrator in the administrative section of the application whereby allowing the administrator to control the selections of products and measurements which may be customized and the selections or portions thereof which are not subject to customization, if any.

4. The multi-point measurements of claim 1, wherein said measurements include in combination: length, linear inches, height, width, radius, diameter.

5. The multi-point measurements of claim 4 further include an algorithmic calculation of any customization in the measurement of feet is converted into inches by the system whereby the system is uniform in its calculations.

6. The method as set forth in claim 1, wherein: said verification of the measurements so that they do not exceed tolerances for manufacture comprises: the administrator setting in certain high and low qualifications for the various point-measurements whereby the potential purchaser cannot customize the order beyond or below a certain pre-determined limit set by the administrator.

7. The method as set forth in claim 1, wherein: said calculations for special and discounted pricing methods are pre-determined in the customer database from previous entries made by the administrator into the system and particularized for specific registered clients recognized by the systems by virtue of their unique log-in identifications whereby the system automatically discounts the price quotes by the discount percentage previously entered by the administrator, if any.

8. The special and discounted pricing methods of claim 7 further include a client identification system which allows the system to utilize the lowest pre-defined price for certain attributes unique for that specific client whereby allowing for the administrator to set the minimum price for that client based on any or all attributes to keep the cost at a competitive level.

9. The method as set forth in claim 1 further includes an up-to-the minute inventory database whereby the system accounts for inventory maintained in accordance and updated when orders are made.

10. The inventory database of claim 8 further includes a method of deducting orders made from the inventory in stock whereby notifying the administrator of the quantity of materials or items left in stock.

10. An apparatus comprising:
an internet merchandising system which generates live price quotes based on calculations of pre-determined algorithmic formulas for customized sheet-metal products based on the customized computations of price-sensitive attributes, including in combination: materials, multi-point measurements, shapes, and weight, within certain tolerances for manufacture;
a pricing method automatically and immediately available upon selection allowing for live pricing methods, including in combination: special pricing based on prior authorization by the administrator whereby the lowest price the administrator is willing to sell for is pre-determined for a specific client, and discount pricing based on prior authorization whereby the principal amount is discounted in it's entirety before taxes by a percentage entered in by the administrator for the specific client.
